(19) United States
(12) Patent Application Publication
(10) Pub. No.: US 2025/0148566 A1
(43) Pub. Date: May 8, 2025

(54) INFORMATION PROCESSING APPARATUS, CONTROL METHOD THEREFOR, AND NON-TRANSITORY STORAGE MEDIUM

(71) Applicant: CANON KABUSHIKI KAISHA, Tokyo (JP)

(72) Inventor: REI ISHIKAWA, Saitama (JP)

(21) Appl. No.: 18/930,366

(22) Filed: Oct. 29, 2024

(30) Foreign Application Priority Data
Nov. 2, 2023 (JP) 2023-188930

(51) Int. Cl. G06T 1/60; G06T 11/60; G06V 10/44

(52) U.S. Cl. CPC G06T 1/60; G06T 11/60; G06V 10/44

(57) ABSTRACT

An information processing apparatus configured to store a plurality of images includes at least one memory storing a program and at least one processor that executes the stored program, which cause the at least one processor to store a storage time-limit of each of the plurality of images, delete an image with the storage time-limit having expired in the plurality of images, determine an output function for the image to be deleted, transmit a notification indicating that the image is to be deleted and the output function to a user, and receive a selection based on a user operation on the output function after the notification is transmitted. The output function for the image to be deleted is determined based on an output function for an image in association with the image to be deleted.

### BACKGROUND

### Field

The present disclosure relates to a method for storing images using an information processing apparatus, and more particularly, to a method for transmitting a notification indicating that there is an image with an approaching storage time-limit to a user.

### Description of the Related Art

A method for storing images captured by an image capturing apparatus using an information processing apparatus has heretofore been in widespread use. If an image capturing apparatus including an image capturing function is connected to a network, the image capturing apparatus transmits images stored in the image capturing apparatus to an information processing apparatus. The information processing apparatus stores the received images and provides a user with a function of outputting images to an outside, for example, a function of printing images, or a function of transmitting images to another user. The provision of such a function facilitates the use of captured images. This leads to an increase in opportunities for users to capture images using an image capturing apparatus and enhancement of attractiveness of image capturing.

Information processing apparatuses provide various image output functions. One example of the image output functions is a function of outputting images onto a printing medium, such as paper, to thereby print photos using a printer, or using a photobook creation service. Another example of the image output functions is a function of transmitting images to another information processing apparatus, thereby downloading images, transmitting images via an email, using a file sharing service, or posting images to a social network service (SNS). The user can use these functions for different purposes depending on the contents of captured images.

There is an upper limit for the number of images that can be stored in an information processing apparatus. The upper limit is determined based on the capacity of a storage device, such as a hard disk, in the information processing apparatus. If the number of stored images has reached the upper limit, images transmitted from an image capturing apparatus cannot be stored in the information processing apparatus. A management device discussed in Japanese Patent Application Laid-Open No. 2018-005921 sets a storage time-limit for each image and automatically deletes images that have reached the storage time-limit, to thereby increase the number of images that can be stored. The management device transmits a notification indicating that some images have an approaching storage time-limit to a user, thereby preventing unintended deletion of images required by the user.

The user that has received the notification indicating that some images are to be deleted needs to check the images to be deleted, determine an image output function for outputting the images from the information processing apparatus, and execute the image output function. However, if the information processing apparatus provides many image output functions, the user needs to select one of the image output functions and make settings for each image output function, which is troublesome for the user.

### SUMMARY

The present disclosure is directed to presenting an image output function to be executed by a user in a notification indicating that some images are to be deleted, thereby improving user-friendliness.

According to an aspect of the present disclosure, an information processing apparatus configured to store a plurality of images includes at least one memory storing a program and at least one processor that executes the stored program, which cause the at least one processor to store a storage time-limit of each of the plurality of images, delete an image with the storage time-limit having expired in the plurality of images, determine an output function for the image to be deleted, transmit a notification indicating that the image is to be deleted and the output function to a user, and receive a selection based on a user operation on the output function after the notification is transmitted. The output function for the image to be deleted is determined based on an output function for an image in association with the image to be deleted.

Further features of the present disclosure will become apparent from the following description of exemplary embodiments with reference to the attached drawings.

### BRIEF DESCRIPTION OF THE DRAWINGS

FIGS. 1A and 1B are block diagrams each illustrating a hardware configuration example of an information processing apparatus.

FIG. 2A is a block diagram illustrating a software configuration example of the information processing apparatus, FIG. 2B is a flowchart illustrating an image storage processing operation to be performed by the information processing apparatus, FIG. 2C is a flowchart illustrating an image deletion processing operation to be performed by the information processing apparatus, and FIG. 2D is a flowchart illustrating an action execution processing operation to be performed by the information processing apparatus.

FIG. 3 is a flowchart illustrating an example of a notification transmission operation to be performed by the information processing apparatus.

FIG. 4A is a flowchart illustrating an example of an image grouping operation to be performed by the information processing apparatus, and FIG. 4B is a flowchart illustrating an example of an action-to-be-suggested determination operation to be performed by the information processing apparatus.

FIG. 5A is a flowchart illustrating an example of a notification time determination operation to be performed by the information processing apparatus, and FIGS. 5B and 5C each illustrate an example of a screen for action execution processing.

FIGS. 6A to 6D each illustrate an example of a screen for notification processing, and FIG. 6E illustrates an example of a data structure for images and tag information.

FIGS. 7A to 7C each illustrate an example of a screen for notification processing, FIG. 7D illustrates an example of a pair of an action and tag information, and FIG. 7E illustrates an example of a data structure for a storage time-limit of an image.

### DESCRIPTION OF THE EMBODIMENTS

Exemplary embodiments of the present disclosure will be described in detail below with reference to the accompanying drawings. Configurations described in the following exemplary embodiments are merely examples, and the present disclosure is not limited to the illustrated configurations.

### Hardware Configuration

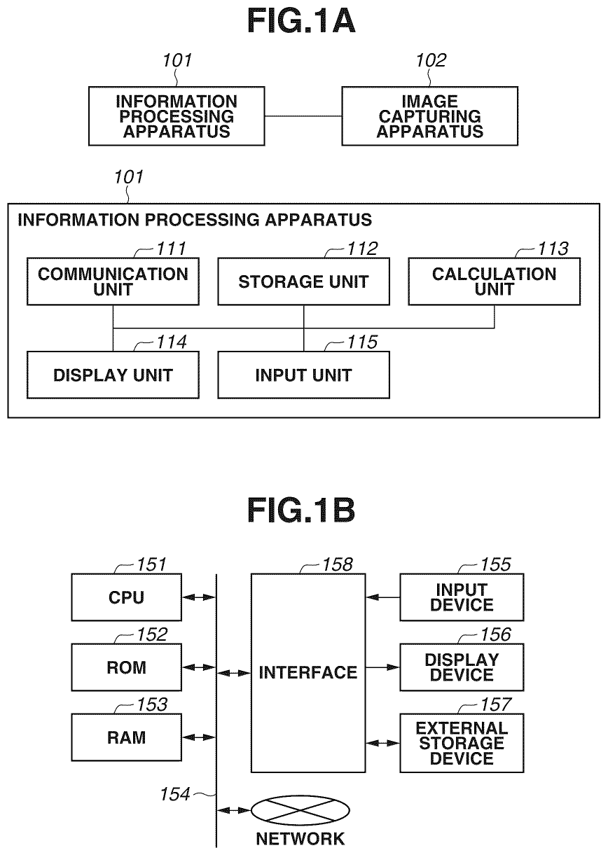

A first exemplary embodiment of the present disclosure will be described. FIG. 1A illustrates a configuration example of an information processing apparatus 101. The information processing apparatus 101 has an image storage function and an image deletion function. The information processing apparatus 101 includes various units, such as a communication unit 111, a storage unit 112, a calculation unit 113, a display unit 114, and an input unit 115. The information processing apparatus 101 is configured to store a plurality of images and is implemented as a server, for example, on a cloud.

The communication unit 111 in the information processing apparatus 101 is a unit configured to transmit and receive information to and from an image capturing apparatus 102. For example, the communication unit 111 is implemented as a network card or the like.

The storage unit 112 is a unit configured to store a plurality of images and details of a user operation received via the input unit 115. For example, the storage unit 112 is implemented as a random access memory (RAM), a read-only memory (ROM), a hard disk drive (HDD), or the like.

The calculation unit 113 is a unit configured to execute transmission and reception of data and storage processing. For example, the calculation unit 113 is implemented as a central processing unit (CPU), a graphics processing unit (GPU), or the like. In the first exemplary embodiment, the calculation unit 113 executes programs stored in the storage unit 112.

The display unit 114 displays various information for a user to operate the information processing apparatus 101. For example, the display unit 114 is implemented as a display or the like.

The input unit 115 is a reception unit that receives various user operations performed by the user operating the information processing apparatus 101. For example, the input unit 115 is implemented as a touch panel or the like.

In the present exemplary embodiment, a description will be mainly provided of a case where images to be used are still images. However, images to be used may be moving images. In other words, the information processing apparatus 101 is configured to store a plurality of still images and a plurality of moving images and to perform processing on any of still images and moving images. In the following description, unless otherwise noted, the term “image” includes concepts of both moving images and still images.

FIG. 1B is a block diagram illustrating a configuration example of a computer system to be used for the information processing apparatus 101 according to the present exemplary embodiment. A CPU 151 executes an operating system (OS) and various application programs to control each unit of the computer system. A ROM 152 stores programs to be executed by the CPU 151 and fixed data in parameters for calculation. A RAM 153 provides a work area for the CPU 151 and a temporary data storage area. The ROM 152 and the RAM 153 are each connected to the CPU 151 via a bus 154. An input device 155, such as a keyboard, a display device 156, such as a cathode ray tube (CRT) or a liquid crystal display, and an external storage device 157, such as a hard disk device, a magneto optical (MO) disk, or a compact disc (CD)-ROM, are connected to the bus 154 via an interface 158. The bus 154 is connected to a network.

### Software Configuration

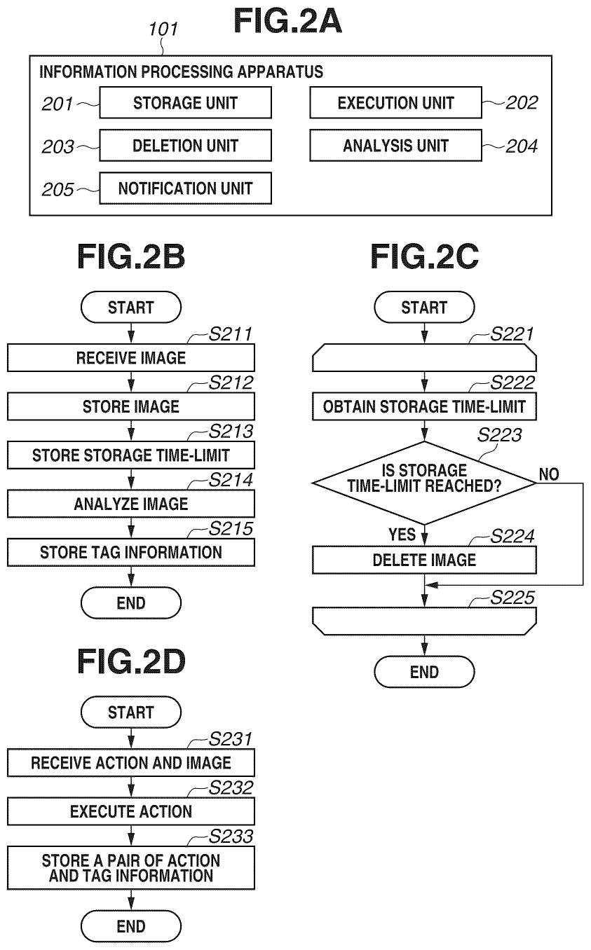

FIG. 2A illustrates a software configuration example of the information processing apparatus 101.

In the present exemplary embodiment, software functional blocks are stored as programs in the storage unit 112, and the programs are executed by the calculation unit 113 to thereby implement the functions. The functions are implemented such that the calculation unit 113 executes the programs to control each hardware device and perform calculations and processing on information. Part or all parts included in each functional block may be configured as a hardware device. In this case, part or all parts included in each functional block are implemented as, for example, an application-specific integrated circuit (ASIC).

In the present exemplary embodiment, the information processing apparatus 101 includes a storage unit 201, an execution unit 202, a deletion unit 203, an analysis unit 204, and a notification unit 205.

The storage unit 201 stores images and a storage time-limit for each of the images

in the storage unit 112. The storage unit 201 also stores tag information output from the analysis unit 204 in the storage unit 112. The storage unit 201 also stores, in the storage unit 112, a pair of an action executed by the execution unit 202 and tag information about a target image on which the action has been executed.

The execution unit 202 executes an action on images stored in the storage unit 201. The user designates an action to be executed by the execution unit 202 via the input unit 115.

The deletion unit 203 deletes an image with the storage time-limit having expired among the images stored in the storage unit 201.

The analysis unit 204 analyzes each image stored in the storage unit 201, and outputs tag information as feature information indicating features of the image based on the analysis result. The storage unit 201 stores the tag information output from the analysis unit 204 in association with the analyzed image. The analysis unit 204 includes an analysis engine including, for example, a convolutional neural network, analyses each image using the analysis engine, and outputs tag information as feature information indicating features of the image, such as “person” or “night view”, based on an analysis result including feature values or the like for the image.

The notification unit 205 transmits a notification indicating that an image is to be deleted by the deletion unit 203 to the user in advance. The notification unit 205 determines a notification timing based on images stored in the storage unit 201, the storage time-limit, the tag information, and a pair of an action and tag information. The notification unit 205 transmits a notification indicating that an image is to be deleted and an action to be executed on the image to be deleted to the user.

### Image Storage Processing

FIG. 2B is a flowchart illustrating an example of image storage processing to be executed by the information processing apparatus 101. The processing illustrated in FIG. 2B is implemented by the calculation unit 113 in the information processing apparatus 101 executing programs stored in the storage unit 112. The processing illustrated in FIG. 2B is started at a timing when the image capturing apparatus 102 starts to transmit an image to the information processing apparatus 101.

In step S211, the storage unit 201 receives an image from the image capturing apparatus 102 via the communication unit 111.

In step S212, the storage unit 201 stores the image received in step S211 in the storage unit 112.

In step S213, the storage unit 201 stores the storage time-limit of the image received in step S211 in the storage unit 112. In the present exemplary embodiment, the storage unit 201 stores information indicating a date after 30 days from the execution of the operation in step S213 as the storage time-limit of the image.

In step S214, the analysis unit 204 analyzes the image stored in the storage unit 201 in step S212, and outputs tag information.

In step S215, the storage unit 201 stores the tag information output from the analysis unit 204 in step S214 in association with the image stored in the storage unit 201 in step S212. Then, the processing of this flowchart ends.

### Image Deletion Processing

FIG. 2C is a flowchart illustrating an example of image deletion processing to be executed by the information processing apparatus 101. The processing illustrated in FIG. 2C is implemented by the calculation unit 113 in the information processing apparatus 101 executing programs stored in the storage unit 112. The processing illustrated in FIG. 2C is periodically executed.

In step S221, the deletion unit 203 executes operations in steps S302 to S309 on the image stored in the storage unit 201.

In step S222, the deletion unit 203 obtains the storage time-limit of the image from the storage unit 201.

In step S223, the deletion unit 203 determines whether the storage time-limit of the image is reached.

If the storage time-limit is reached (YES in step S223), the processing proceeds to step S224. If the storage time-limit is not reached (NO in step S223), the processing proceeds to step S225.

In step S224, the deletion unit 203 deletes the image.

In step S225, if the deletion unit 203 has completed the processing on all images, the processing of this flowchart is ended. If the processing on all images is not completed, the processing returns to step S221 to execute the processing on an image on which the processing has not been executed.

### Action Execution Processing

FIG. 2D is a flowchart illustrating an example of action execution processing to be executed by the information processing apparatus 101. The processing illustrated in FIG. 2D is implemented by the calculation unit 113 in the information processing apparatus 101 executing programs stored in the storage unit 112.

In step S231, the execution unit 202 receives a user operation from the user via the input unit 115, thus receiving designation of an action and a target image on which the action is to be executed.

In step S232, the execution unit 202 executes the action corresponding to the designation of the action received in step S231 on the target image the designation of which is received in step S231.

In step S233, the storage unit 201 stores a pair of the action executed in step S232 and tag information in association with the target image received in step S231.

### Notification Processing

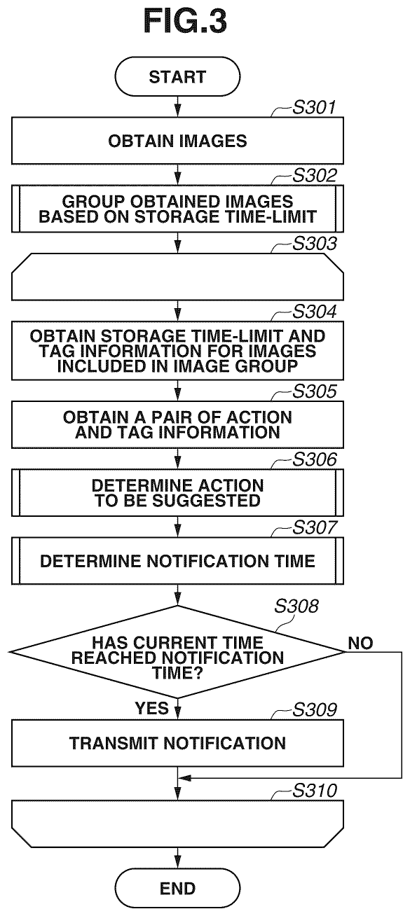

FIG. 3 is a flowchart illustrating an example of processing for the notification unit 205 to transmit a notification to the user.

In step S301, the notification unit 205 obtains images from the storage unit 201.

In step S302, the notification unit 205 groups the images obtained in step S301 based on the storage time-limit. In this processing, one or more image groups are generated. Each image group includes one or more images.

In step S303, the notification unit 205 selects a certain image group from among the one or more image groups generated in step S302, and executes operations in steps S304 to step S309.

In step S304, the notification unit 205 obtains the storage time-limit and tag information for each of the images included in the image group from the storage unit 201.

In step S305, the notification unit 205 obtains a pair of an action and tag information from the storage unit 201.

In step S306, the notification unit 205 determines an action to be suggested to the user based on the tag information about each image included in the image group obtained in step S303 and the pair of the action and the tag information obtained in step S304.

In step S307, the notification unit 205 determines a notification time when a notification is transmitted to the user based on the action determined in step S306.

In step S308, the notification unit 205 determines whether the current time has reached the notification time. If the current time has reached the notification time (YES in step S308), the processing proceeds to step S309. If the current time has not reached the notification time (NO in step S308), the processing proceeds to step S310.

In step S309, the notification unit 205 transmits a notification indicating that the storage time-limit of the image is approaching and the action determined in step S306 to the user.

In step S310, the notification unit 205 executes the processing on all image groups generated in step S302, and then the processing of this flowchart ends.

### Image Grouping Processing

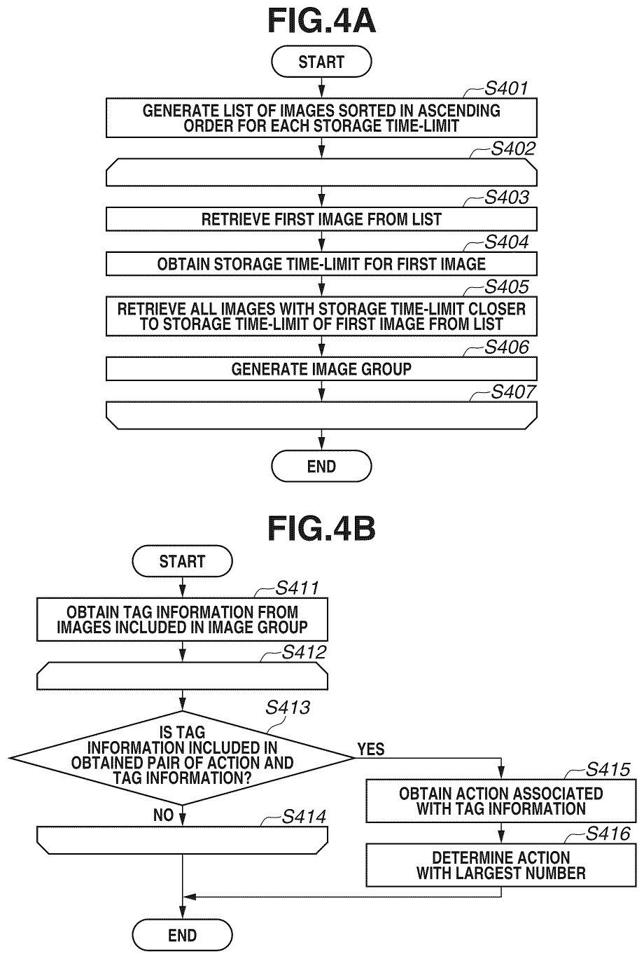

FIG. 4A is a flowchart illustrating detailed processing in which the notification unit 205 generates one or more image groups in step S302.

In step S401, the notification unit 205 generates a list of images sorted in ascending order for each storage time-limit.

In step S402, the notification unit 205 executes operations in steps S403 to S407 until the list generated in step S401 becomes empty.

In step S403, the notification unit 205 retrieves the first image in the list generated in step S401.

In step S404, the notification unit 205 obtains the storage time-limit of the image retrieved in step S403 from the storage unit 201.

In step S405, the notification unit 205 retrieves all images with a storage time-limit close to the storage time-limit obtained in step S404 from the list generated in step S401. According to the present exemplary embodiment, in step S405, all images with a difference from the storage time-limit obtained in step S404 falling within three days are retrieved from the list generated in step S401.

In step S406, the notification unit 205 generates an image group including the image retrieved in step S403 and all the images retrieved in step S405.

In step S407, the notification unit 205 repeatedly executes the operation in steps S403 to S407 until the list generated in step S401 becomes empty, and then the processing of this flowchart ends. The operations in step S303 and subsequent steps are performed on all image groups generated in step S405.

### Processing of Determining Action to be Suggested

FIG. 4B is a flowchart illustrating detailed processing for the notification unit 205 to determine an action to be suggested in step S306.

In step S411, the notification unit 205 obtains tag information and the number of pieces of tag information included in the images from all the images included in the one or more image groups generated in step S302.

In step S412, the notification unit 205 sorts the pieces of tag information obtained in step S411 in descending order of the number of pieces of tag information included in the images, and operations in steps S413 and S414 are executed on the pieces of tag information in order from the first tag information.

In step S413, the notification unit 205 determines whether the tag information selected in step S412 is included in the tag information in the pair of the action and the tag information obtained in step S305. If the tag information is included in the pair of the action and the tag information (YES in step S413), the processing proceeds to step S415. If the tag information is not included in the pair of the action and the tag information (NO in step S413), the processing proceeds to step S414.

In step S414, the notification unit 205 executes the processing on all pieces of tag information and determines whether there is no action to be suggested. The processing of this flowchart is then ended.

In step S415, the notification unit 205 obtains an action in association with the tag information selected in step S412 from the pair of the action and the tag information obtained in step S305.

In step S416, the notification unit 205 determines the action with the largest number of the pairs of the action and the tag information obtained in step S305, among the actions obtained in step S415, to be the action to be suggested to the user, and then the processing of this flowchart ends.

### Notification Time Determination Processing

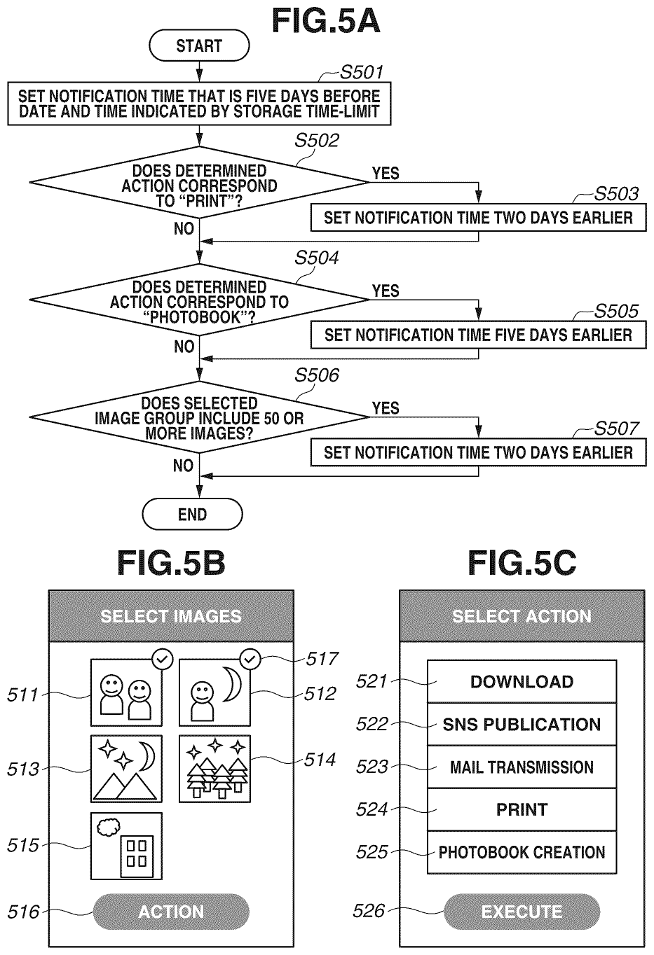

FIG. 5A is a flowchart illustrating detailed processing for the notification unit 205 to determine the notification time in step S307.

In step S501, the notification unit 205 obtains the earliest storage time-limit among the storage time-limits of the images included in the image group selected in step S303, and sets the notification time that is five days before the date and time indicated by the storage time-limit.

In step S502, the notification unit 205 determines whether the action determined to be suggested to the user in step S306 corresponds to “print”. If the action to be suggested corresponds to “print” (YES in step S502), the processing proceeds to step S503. If the action to be suggested does not correspond to “print” (NO in step S502), the processing proceeds to step S504.

In step S503, the notification unit 205 sets the notification time two days earlier.

In step S504, the notification unit 205 determines whether the action determined to be suggested to the user in step S306 corresponds to “photobook”. If the action to be suggested to the user corresponds to “photobook” (YES in step S504), the processing proceeds to step S505. If the action to be suggested to the user does not correspond to “photobook” (NO in step S504), the processing proceeds to step S506.

In step S505, the notification unit 205 sets the notification time five days earlier.

In step S506, the notification unit 205 determines whether 50 or more images are included in the image group selected in step S303. If 50 or more images are included in the image group (YES in step S506), the processing proceeds to step S507. If less than 50 images are included in the image group (NO in step S506), the processing of this flowchart is ended.

In step S507, the notification unit 205 sets the notification time two days earlier, and then the processing of this flowchart is ended.

### Screen Examples

FIG. 5B illustrates an example of a screen for receiving designation of a target image on which the execution unit 202 is to execute an action in step S231 after the notification is transmitted to the user by the notification unit 205 via the input unit 115.

Images 511 to 515 correspond to images A to E, respectively, that are stored in the storage unit 201.

These images can be selected as a target image on which an action is to be executed.

When an action button 516 is pressed, the execution unit 202 displays an action selection screen.

A selection icon 517 represents an image that is selected by the user, where the selection is received via a user operation.

FIG. 5C illustrates an example of the action selection screen for the execution unit 202 to receive designation of an action to be executed via the input unit 115 in step S231 after the notification is transmitted to the user by the notification unit 205.

If the user selects and executes a download action 521, the execution unit 202 transmits the selected images to a storage device owned by the user via the communication unit 111 and causes the images to be downloaded to the storage device.

If the user selects and executes a social network system (SNS) publication action 522, the execution unit 202 uploads the selected images to an SNS service registered by the user via the communication unit 111, and causes the images to be publicized.

If the user selects and executes a mail transmission action 523, the execution unit 202 attaches the selected images to an email via the communication unit 111, and transmits the email to a predetermined email address registered by the user.

If the user selects and executes a print action 524, the execution unit 202 transmits the selected images to a printing apparatus via the communication unit 111 and causes the printing apparatus to print the images.

If the user selects and executes a photobook creation action 525, the execution unit 202 creates a photobook using the selected images via the communication unit 111.

If the user presses an execution button 526, the execution unit 202 executes the action selected by the user.

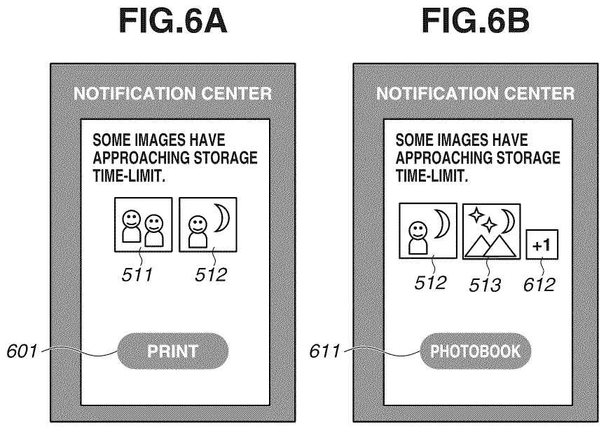

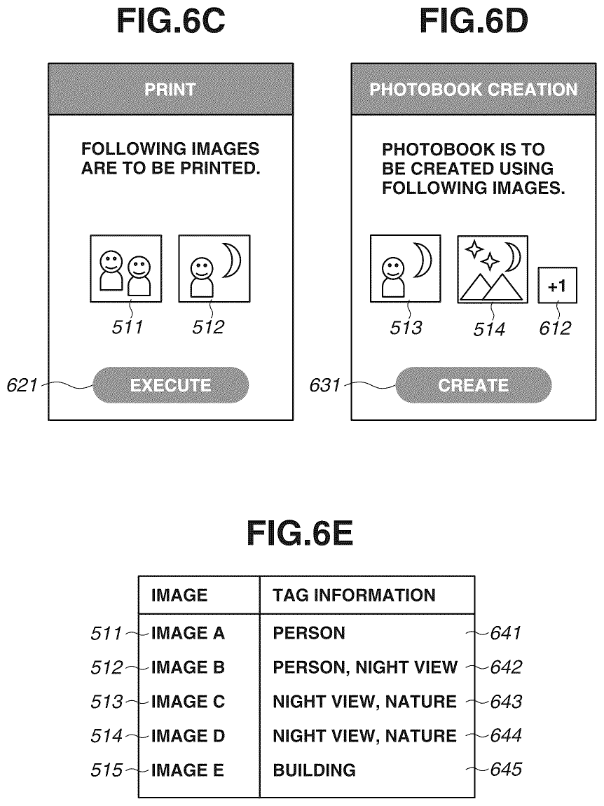

FIGS. 6A and 6B each illustrate an example of a screen for the notification unit 205 to transmit a notification indicating that some images have an approaching storage time-limit and the action determined in step S306 to the user in step S309.

FIG. 6A illustrates a notification indicating that the storage time-limit of each of the image A 511 and the image B 512 is approaching.

A screen of a print screen display button 601 suggests execution of the print action 524 on the image A 511 and the image B 512 to the user. When the print screen display button 601 is pressed, the execution unit 202 displays a print screen.

FIG. 6B illustrates a notification indicating that the storage time-limit of each of the image B 512, the image C 513, and the image D 514 is approaching.

A screen of a photobook creation screen display button 611 suggests execution of the photobook creation action 525 on the image B 512, the image C 513, and the image D 514 to the user. When the photobook creation screen display button 611 is pressed, the execution unit 202 displays a photobook creation screen.

When the user presses an all images display button 612, the notification unit 205 displays the image D 514 that is not displayed on the screen.

FIG. 6C illustrates an example of the print screen to be displayed after the print screen display button 601 is pressed on the screen illustrated in FIG. 6A.

When a print button 621 is pressed, the print action 524 is executed on the image A 511 and the image B 512.

FIG. 6D illustrates an example of the photobook creation screen to be displayed after the photobook creation screen display button 611 is pressed on the screen illustrated in FIG. 6B.

When a photobook creation button 631 is pressed, the photobook creation action 525 is executed on the image B 512, the image C 513, and the image D 514.

### Data Example

FIG. 6E illustrates an example of images and tag information stored by the storage unit 201.

An item 641 indicates that tag information “person” is stored in association with the image A 511.

An item 642 indicates that tag information “person” and tag information “night view” are stored in association with the image B 512.

An item 643 indicates that tag information “night view” and tag information “nature” are stored in association with the image C 513.

An item 644 indicates that tag information “night view” and tag information “nature” are stored in association with the image D 514.

An item 645 indicates that tag information “building” is stored in association with the image E 515.

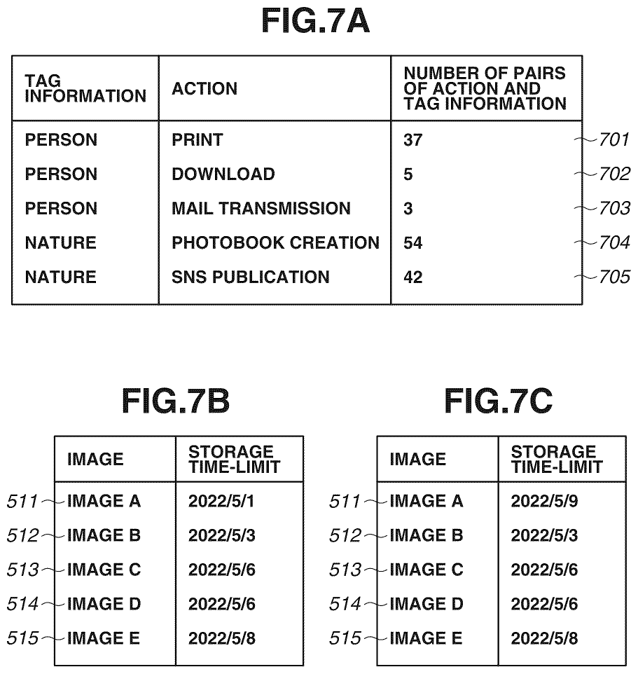

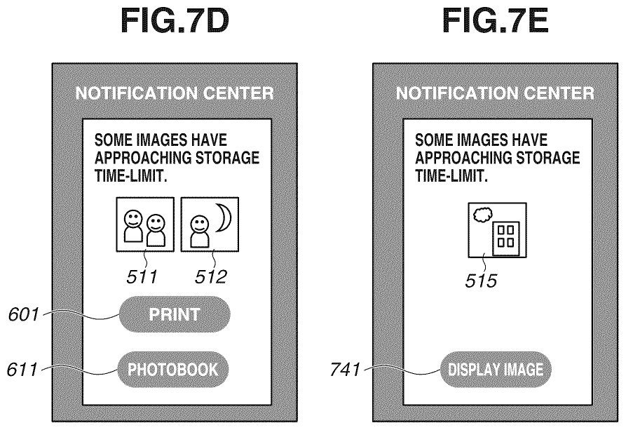

FIG. 7A illustrates examples of a pair of an action and tag information stored in the storage unit 201.

An item 701 indicates that there are 37 pairs of tag information “person” and the print action 524.

An item 702 indicates that there are five pairs of tag information “person” and the download action 521.

An item 703 indicates that there are three pairs of tag information “person” and the mail transmission action 523.

An item 704 indicates that there are 54 pairs of tag information “nature” and the photobook creation action 525.

An item 705 indicates that there are 42 pairs of tag information “nature” and the SNS publication action 522.

### Notification Processing 1

Processing for the information processing apparatus 101 to execute notification processing and display the notification screen illustrated in FIG. 6A will be described below with reference to flowcharts of FIGS. 3 and 4A. In the following description, assume that the storage unit 201 stores the images and tag information illustrated in FIG. 6E; the storage unit 201 stores the pairs of an action and tag information illustrated in FIG. 7A; the storage unit 201 stores the storage time-limits illustrated in FIG. 7B; and the current time is “2022 Apr. 25”.

In step S301, the notification unit 205 obtains the images A 511 to E 515 from the storage unit 201.

In step S302, the notification unit 205 groups the obtained images based on the storage time-limit.

In step S401, the notification unit 205 generates a list of images sorted in ascending order based on the storage time-limit. As a result, the generated list includes the image A 511, the image B 512, the image C 513, the image D 514, and the image E 515 arranged in this order as elements of the list.

In step S403, the notification unit 205 retrieves the image A 511 from the list.

In step S404, the notification unit 205 obtains the storage time-limit of the image A 511 from the storage unit 201. The obtained storage time-limit is “2022 May 1”.

In step S405, the notification unit 205 retrieves the image B 512 as the image with a difference from the storage time-limit “2022 May 1” falling within three days.

In step S406, the notification unit 205 generates an image group including the image A 511 and the image B 512. This image group is referred to as an image group P.

In step S407, the processing returns to step S402.

In step S403, the notification unit 205 retrieves the image C 513 from the list.

In step S404, the notification unit 205 obtains the storage time-limit of the image C 513 from the storage unit 201. The obtained storage time-limit is “2022 May 6”.

In step S405, the notification unit 205 retrieves the image D 514 and the image E 515 as the image with a difference from the storage time-limit “2022 May 6” falling within three days.

In step S406, the notification unit 205 generates an image group including the image C 513, the image D 514, and the image E 515. This image group is referred to as an image group Q.

In step S303, the notification unit 205 executes the subsequent processing on the image group P.

In step S304, the notification unit 205 obtains the storage time-limit and tag information for the image A 511 and the image B 512 included in the image group P from the storage unit 201. The storage time-limit of the image A 511 is “2022 May 1” and tag information “person” is obtained. The storage time-limit of the image B 512 is “2022 May 3”, and tag information “person” and tag information “night view” are obtained.

In step S305, the notification unit 205 obtains each pair of an action and tag information illustrated in FIG. 7A from the storage unit 201.

In step S306, the notification unit 205 determines an action to be suggested.

In step S411, the notification unit 205 obtains tag information and the number of images including the tag information.

The number of pieces of tag information “person” is two, and the number of pieces of tag information “night view” is one.

In step S412, the notification unit 205 sequentially executes the operations in steps S413 and S414 on tag information “person” and tag information “night view” in this order.

In step S413, the notification unit 205 determines that tag information “person” is included in the pair of the action and the tag information illustrated in FIG. 7A.

In step S415, the notification unit 205 obtains the print action 524, the download action 521, and the mail transmission action 523 as actions in association with tag information “person”.

In step S416, the notification unit 205 determines the print action 524 with the largest number, which is 37, to be the action to be suggested to the user among the actions obtained in step S415.

In step S307, the notification unit 205 determines the notification time.

In step S501, the notification unit 205 sets the notification time “2022 Apr. 26” which is five days before the storage time-limit of the image A 511 with the earliest storage time-limit.

In step S502, the notification unit 205 determines that the action to be suggested corresponds to the print action 524 (YES in step S502), and then the processing proceeds to step S503.

In step S503, the notification unit 205 sets the notification time “2022 Apr. 24” which is two days earlier than the originally set notification time.

In step S504, the notification unit 205 determines that the action to be suggested does not correspond to the photobook creation action 525 (NO in step S504), and then the processing proceeds to step S506.

In step S506, the notification unit 205 determines that less than 50 images are included (NO in step S506), and then the processing proceeds to step S308.

In step S308, the notification unit 205 determines that the current time “2022 Apr. 25” has passed the notification time “2022 Apr. 24” (YES in step S308), and then the processing proceeds to step S309.

In step S309, the notification unit 205 transmits a notification. FIG. 6A illustrates a screen example for the notification to be transmitted.

In step S310, the notification unit 205 has not completed the processing on all image groups. Accordingly, the processing proceeds to step S303.

In step S303, the notification unit 205 executes the subsequent processing on the image group Q.

In step S304, the notification unit 205 obtains the storage time-limit and tag information for the image C 513, the image D 514, and the image E 515 included in the image group Q from the storage unit 201.

In step S305, the notification unit 205 obtains each pair of an action and the tag information illustrated in FIG. 7A from the storage unit 201.

In step S306, the notification unit 205 determines an action to be suggested.

In step S411, the notification unit 205 obtains tag information and the number of images including the tag information.

The number of pieces of tag information “nature” is two, the number of pieces of tag information “night view” is two, and the number of pieces of tag information “building” is one.

In step S412, the notification unit 205 sequentially executes the operations in steps S413 and S414 on tag information “nature”, tag information “night view”, and tag information “building” in this order.

In step S413, the notification unit 205 determines that tag information “nature” is included in the pair of the action and tag information illustrated in FIG. 7A.

In step S415, the notification unit 205 obtains the photobook creation action 525 and the SNS publication action 522 as actions in association with tag information “nature”.

In step S416, the notification unit 205 determines the photobook creation action 525 with the largest number, which is 54, to be the action to be suggested to the user among the actions obtained in step S415.

In step S307, the notification unit 205 determines the notification time.

In step S501, the notification unit 205 sets the notification time “2022 May 1” which is five days before the storage time-limit of the image C 513 with the earliest storage time-limit.

In step S502, the notification unit 205 determines that the action to be suggested does not correspond to the print action 524 (NO in step S502), and then the processing proceeds to step S504.

In step S504, the notification unit 205 determines that the action to be suggested corresponds to the photobook creation action 525 (YES in step S504), and then the processing proceeds to step S505.

In step S505, the notification unit 205 sets the notification time “2022 Apr. 26” that is five days earlier than the originally set notification time.

In step S506, the notification unit 205 determines that less than 50 images are included (NO in step S506), and then the processing proceeds to step S308.

In step S308, the notification unit 205 determines that the current time “2022 Apr. 25” has not reached the notification time “2022 Apr. 26” (NO in step S308), and then the processing proceeds to step S310.

In step S310, the notification unit 205 has completed the processing on all image groups, and thus the processing ends.

### Notification Processing 2

Processing for the information processing apparatus 101 to execute notification processing and display the notification screen illustrated in FIG. 6B will be described with reference to the flowcharts of FIGS. 3 and 4A. In the following description, assume that the storage unit 201 stores the images and tag information illustrated in FIG. 6E; the storage unit 201 stores the pairs of an action and tag information illustrated in FIG. 7A; the storage unit 201 stores the storage time-limits illustrated in FIG. 7C; and the current time is “2022 Apr. 25”.

In step S301, the notification unit 205 obtains the images A 511 to E 515 from the storage unit 201.

In step S302, the notification unit 205 groups the obtained images based on the storage time-limit.

In step S401, the notification unit 205 generates a list of images sorted in ascending order based on the storage time-limit. As a result, the generated list includes the image B 512, the image C 513, the image D 514, the image E 515, and the image A 511 arranged in this order as elements.

In step S403, the notification unit 205 retrieves the image B 512 from the list.

In step S404, the notification unit 205 obtains the storage time-limit of the image B 512 from the storage unit 201. The obtained storage time-limit is “2022 May 3”.

In step S405, the notification unit 205 retrieves the image C 513 and the image D 514 as the image with a difference from the storage time-limit “2022 May 3” falling within three days.

In step S406, the notification unit 205 generates an image group including the image B 512, the image C 513, and the image D 514. This image group is referred to as an image group R.

In step S407, the processing to be performed by the notification unit 205 returns to step S402.

In step S403, the notification unit 205 retrieves the image E 515 from the list.

In step S404, the notification unit 205 obtains the storage time-limit of the image E 515 from the storage unit 201. The obtained storage time-limit is “2022 May 8”.

In step S405, the notification unit 205 retrieves the image A 511 as the image with a difference from the storage time-limit “2022 May 8” falling within three days.

In step S406, the notification unit 205 generates an image group including the image E 515 and the image A 511. This image group is referred to as an image group S.

In step S303, the notification unit 205 executes the subsequent processing on the image group R.

In step S304, the notification unit 205 obtains the storage time-limit and tag information for the image B 512, the image C 513, and the image D 514 included in the image group R from the storage unit 201. The storage time-limit of the image B 512 is “2022 May 3”, and tag information “person” and tag information “night view” are obtained. The storage time-limit of the image C 513 is “2022 May 6”, and tag information “night view” and tag information “nature” are obtained. The storage time-limit of the image D 514 is “2022 May 6”, and tag information “night view” and tag information “nature” are obtained.

In step S305, the notification unit 205 obtains each pair of an action and tag information illustrated in FIG. 7A from the storage unit 201.

In step S306, the notification unit 205 determines an action to be suggested.

In step S411, the notification unit 205 obtains tag information and the number of images including the tag information.

The number of pieces of tag information “night view” is three, and the number of pieces of tag information “nature” is two.

In step S412, the notification unit 205 sequentially executes the operations in steps S413 and S414 on tag information “night view” and tag information “nature” in this order.

In step S413, the notification unit 205 determines that tag information “night view” is not included in the pair of the action and the tag information illustrated in FIG. 7A.

In step S414, the notification unit 205 has not completed the processing on all pieces of tag information. Accordingly, the processing proceeds to step S412.

In step S413, the notification unit 205 determines that tag information “nature” is included in the pair of the action and the tag information illustrated in FIG. 7A.

In step S415, the notification unit 205 obtains the photobook creation action 525 and the SNS publication action 522 as actions in association with the tag information “nature”.

In step S416, the notification unit 205 determines the photobook creation action 525, which is the largest number, which is 54, to be the action to be suggested to the user among the actions obtained in step S415.

In step S307, the notification unit 205 determines the notification time.

In step S501, the notification unit 205 sets the notification time “2022 Apr. 28” which is five days before the storage time-limit of the image B 512 with the earliest storage time-limit.

In step S502, the notification unit 205 determines that the action to be suggested does not correspond to the print action 524 (NO in step S502), and then the processing proceeds to step S504.

In step S504, the notification unit 205 determines that the action to be suggested corresponds to the photobook creation action 525 (YES in step S504), and then the processing proceeds to step S505.

In step S505, the notification unit 205 sets the notification time “2022 Apr. 23” which is five days earlier than the originally set notification time.

In step S506, the notification unit 205 determines that less than 50 images are included (NO in step S506), and then the processing proceeds to step S308.

In step S308, the notification unit 205 determines that the current time “2022 Apr. 25” has passed the notification time “2022 Apr. 23” (YES in step S308), and then the processing proceeds to step S309.

In step S309, the notification unit 205 transmits a notification. FIG. 6A illustrates a screen example for the notification to be transmitted.

In step S310, the notification unit 205 has not completed the processing on all the image groups. Accordingly, the processing proceeds to step S303.

In step S303, the notification unit 205 executes the subsequent processing on the image group S.

In step S304, the notification unit 205 obtains the storage time-limit and tag information for the image E 515 and the image A 511 included in the image group S from the storage unit 201.

In step S305, the notification unit 205 obtains each pair of an action and tag information illustrated in FIG. 7A from the storage unit 201.

In step S306, the notification unit 205 determines an action to be suggested.

In step S411, the notification unit 205 obtains tag information and the number of images including the tag information.

The number of pieces of tag information “person” is one and the number of pieces of tag information “building” is one.

In step S412, the notification unit 205 sequentially executes the operations in steps S413 and S414 on tag information “person” and tag information “building” in this order.

In step S413, the notification unit 205 determines that the tag information “person” is included in the pair of the action and the tag information illustrated in FIG. 7A.

In step S415, the notification unit 205 obtains the print action 524, the download action 521, and the mail transmission action 523 as actions in association with the tag information “person”.

In step S416, the notification unit 205 determines that the print action 524 with the largest number, which is 37, to be the action to be suggested to the user among the actions obtained in step S415.

In step S307, the notification unit 205 determines the notification time.

In step S501, the notification unit 205 sets the notification time “2022 May 3” which is five days before the storage time-limit of the image E 515 with the earliest storage time-limit.

In step S502, the notification unit 205 determines that the action to be suggested corresponds to the print action 524 (YES in step S502), and then the processing proceeds to step S503.

In step S503, the notification unit 205 sets the notification time “2022 May 1” that is two days earlier than the originally set notification time.

In step S504, the notification unit 205 determines that the action to be suggested does not correspond to the photobook creation action 525 (NO in step S504), and then the processing proceeds to step S506.

In step S506, the notification unit 205 determines that less than 50 images are included (NO in step S506), and then the processing proceeds to step S308.

In step S308, the notification unit 205 determines that the current time “2022 Apr. 25” has not reached the notification time “2022 May 1” (NO in step S308), and then the processing proceeds to step S310.

In step S310, the notification unit 205 has completed the processing on all image groups, and thus the processing is ended.

As described above, according to the present exemplary embodiment, in the case of transmitting a notification indicating that some images have an approaching storage time-limit to the user, an action to be executed on the images can be suggested to the user, thus facilitating the user to use the images to be deleted.

The notification unit 205 may transmit a plurality of notifications about actions to be presented to the user. FIG. 7D illustrates an example where two actions are presented to the user by transmitting a notification indicating that the storage time-limit of each of the image A 511 and the image B 512 is approaching and displaying the print screen display button 601 and the photobook creation screen display button 611.

If tag information in association with an image with an approaching storage time-limit is not included in a pair of an action and tag information, the notification unit 205 may present a notification about execution of a default action to the user. FIG. 7E illustrates an example where a notification indicating that the storage time-limit of the image E 515 is approaching and an image display button 741 are displayed. In this case, the default action is displayed as an image because tag information in association with the image E 515 is not included in the pair of the action and the tag information.

In the present exemplary embodiment, “year”, “month”, and “day” are used to represent the storage time-limit and the current time. In addition, “hour”, “minute”, and “second” may also be used.

If there is a plurality of pieces of tag information in association with the largest number of images in step S412, the notification unit 205 may sequentially execute the operation in step S413 and the subsequent operations in order from specific tag information. For example, if the degree of accuracy of analyzing tag information by the analysis unit 204 varies depending on each piece of tag information, the processing may be sequentially executed on the pieces of tag information in order from tag information with the highest degree of analysis accuracy.

If there is a plurality of actions with the largest number of images is present in step S416, the notification unit 205 may preferentially present a specific action to the user. For example, the notification unit 205 may present printing and photobook creation to the user in priority to the other actions.

The analysis unit 204 may analyze images using another neural network or a feature amount extraction unit.

The storage unit 201 may determine the storage time-limit based on an input from the user.

### Other Exemplary Embodiments

The above-described exemplary embodiments illustrate examples of processing to be performed by the information processing apparatus 101. The present disclosure is not limited to the above-described exemplary embodiments, and various modifications may be made. Some of the above-described exemplary embodiments may be combined as appropriate.

At least some of the processing illustrated in FIGS. 2B, 2C, 2D, 3, 4A, 4B, and 5A may be implemented by one or more dedicated hardware devices different from the calculation unit 113.

The information processing apparatus 101 may include an authentication system, and the image capturing apparatus 102 may add a user identification (ID) and a password to data to be communicated. The addition of a user ID enables the information processing apparatus 101 to determine whether images transmitted from the image capturing apparatus 102 are based on the permission of the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-188930, filed Nov. 2, 2023, which is hereby incorporated by reference herein in its entirety.

What is claimed is:

1. An information processing apparatus configured to store a plurality of images, comprising:
at least one memory storing a program; and
at least one processor that executes the stored program, which cause the at least one processor to:
store a storage time-limit of each of the plurality of images;
delete an image with the storage time-limit having expired in the plurality of images;
determine an output function for the image to be deleted;
transmit a notification indicating that the image is to be deleted and the output function to a user; and
receive a selection based on a user operation on the output function after the notification is transmitted,
wherein the output function for the image to be deleted is determined based on an output function for an image in association with the image to be deleted.

2. The information processing apparatus according to claim 1, wherein the one or more processors and the one or more memories are further cooperating to: obtain feature information about the plurality of images, and store a pair of the feature information and the output function for the image.

3. The information processing apparatus according to claim 2, wherein the one or more processors and the one or more memories are further cooperating to determine the output function for the image to be deleted based on the feature information about the image to be deleted.

4. The information processing apparatus according to claim 1, wherein the one or more processors and the one or more memories are further cooperating to determine a notification time for the notification about the image based on the storage time-limit of the image, and transmit the notification about the image to the user based on expiration of the notification time.

5. The information processing apparatus according to claim 1, wherein the one or more processors and the one or more memories are further cooperating to determine a notification time for the notification about the image based on the storage time-limit of the image and the output function for the image, and transmit the notification about the image to the user based on expiration of the notification time.

6. The information processing apparatus according to claim 1, wherein the one or more processors and the one or more memories are further cooperating to transmit, to the user, a notification indicating that a plurality of images including the image is to be deleted and an output function for the plurality of images based on the storage time-limit.

7. The information processing apparatus according to claim 6, wherein the one or more processors and the one or more memories are further cooperating to determine a notification time for the notification about the plurality of images based on the number of the plurality of images, and transmit the notification about the plurality of images to the user based on expiration of the notification time.

8. The information processing apparatus according to claim 6, wherein the output function is any one of downloading of an image from the information processing apparatus, uploading of an image to a social network service (SNS), transmission of an image to a predetermined email address, printing of an image, or creation of a photobook including an image.

9. A control method for an information processing apparatus configured to store a plurality of images, the control method comprising:
storing a storage time-limit of each of the plurality of images;
deleting an image with the storage time-limit having expired in the plurality of images;
determining an output function for the image to be deleted;
transmitting a notification indicating that the image is to be deleted and the determined output function to a user; and
receiving a selection based on a user operation on the output function after the notification is transmitted,
wherein the output function for the image to be deleted is determined based on an output function for an image in association with the image to be deleted.

10. A non-transitory storage medium storing a program causing an information processing apparatus configured to store a plurality of images to execute a control method, the control method comprising:
storing a storage time-limit of each of the plurality of images;
deleting an image with the storage time-limit having expired in the plurality of images;
determining an output function for the image to be deleted;
transmitting a notification indicating that the image is to be deleted and the determined output function to a user; and
receiving a selection based on a user operation on the output function after the notification is transmitted,
wherein the output function for the image to be deleted is determined based on an output function for an image in association with the image to be deleted.
